(19) United States
(12) Patent Application Publication
(10) Pub. No.: US 2004/0021584 A1
(43) Pub. Date: Feb. 5, 2004

(54) Market status icons in real-estate information search and retrieval system

(76) Inventors: Daniel K. Hartz JR., Fairfax, VA (US); Michael T. Gorman, Arlington, VA (US)

Correspondence Address: Edward J. Kondracki, Miles & Stockbridge P.C., Suite 500, 1751 Pinnacle Drive, McLean, VA, 22102-3833, US

(21) Appl. No.: 10/437,979

(22) Filed: May 15, 2003

Related U.S. Application Data
(63) Continuation-in-part of application No. 09/996,744, filed on Nov. 30, 2001, now Pat. No. 6,636,803.

(51) Int. Cl. G01C 21/30

(52) U.S. Cl. 340/995.24

(57) ABSTRACT

The present invention is directed to icons used to represent properties in a real-estate market information system. The icons of the present invention provide additional information about the property associated with the icon when displayed on a digital map.

Icon indicia, such as shape, color or size, in the present invention is determined by combining at least two property attributes of the property associated with the property icon. In a preferred embodiment, the icons used in the present invention are indicative of the type of property and the market status of the property associated with the icon. The icons can be constructed such that further property attributes, such as square-footage range, could be also, or alternatively, be indicated by icon indicia.

### CROSS-REFERENCE TO RELATED APPLICATION

This application is a continuation-in-part of application Ser. No. 09/996,774 filed Nov. 13, 2001.

### FIELD OF THE INVENTION

This invention generally relates to information search and retrieval systems, and more particularly to a system and method for locating and identifying property in connection with a real-estate transaction. Specifically, the market status icons used in the present invention allow users to quickly determine location, property type and market status of properties in the market within a geographical area.

### DESCRIPTION OF THE RELATED ART

Buying a home can be one of the most important experiences in a person's life, and one of the most expensive. The home a person buys ultimately depends on the quantity and quality of information he or she is able to obtain about the market place prior to purchase. Locating this information for the buyer is one of the important responsibilities of a real estate agent.

Some of the techniques currently in use by real estate agents are antiquated and frequently ineffective. Typically, during an initial consultation with a prospective buyer, the prospective buyer gives the agent an idea of the type of property he or she would like to buy or rent, a price range the prospective buyer can afford, and a general desired location. Based on this information, the agent searches the Multiple Listing Service (MLS) database to locate properties that are currently available and meet the prospective buyer's criteria. Subsequent meetings are then set prospective buyer for the purpose of visiting those properties.

During subsequent meetings, the agent must determine exactly where ties are located, and a route must then be plotted for visiting those This is usually done using paper maps and printouts of MLS listings, agent often carries within him in the car. The use of paper maps and MLS proven to be time-consuming, cumbersome, and generally inefficient.

Another drawback of current techniques relates to the need to visit properties within the desired geographical area. Once the agent general geographic area of interest to the prospective buyer, he usually prospective buyer to each of the properties. Many times, however, the buyer does not even enter the properties because he can tell from just their pearance that they are unsuitable to his tastes. The need to physically visit very property in a market to determine whether their suitability wastes the buyer's and agent's time and, further, adds to the inefficiency of the ng experience.

Undoubtedly, there is a need for the real-estate industry to embrace logies in meeting buyers' needs. It has been reported that nearly twol real estate brokers do not have a web presence, and nearly one third do e e-mail in their jobs. While this trend is slowly changing, the underlying mains substantially the same. In the vast majority of cases, real-estate rely on paper resources to develop property tours for prospective buyers l required to chauffeur customers to physical property sites.

In view of the foregoing considerations, it is clear that there is a need oved system and method for developing and presenting property that can be used by real-estate agents in assisting their customer needs. The assignee of the present invention has developed such as system, as is disclosed in co-pending U.S. patent application Ser. No. 09/996,744, entitled “Real-Estate Information Search and Retrieval System”, the subject matter of said application is hereby incorporated by reference in its entirety. Application Ser. No. 09/996,744 discloses a system that uses digital technology to substantially reduce or altogether replace the paper resources an agent must rely on to obtain property information in a real-estate market. A data terminal equipped with management software provides a digital guided tour of a/particular area of a real-estate market by integrating a digital map with property information. In the disclosed system, a property in the real estate market is shown on the digital map as an icon placed at the property's street address. Notwithstanding the technological advances made by this system, it would be useful and advantageous to be able to quickly ascertain not only locations of properties, but property type and market status, from the digital map produced by the disclosed system. The present invention provides such an ability.

### SUMMARY OF THE INVENTION

It is the objective of the present invention to achieve the aforementioned ability by using icons indicative of more than location to represent properties on a digital map.

The foregoing and other objects of the invention are achieved by a system and method for providing property information to prospective real estate buyers, lessors or renters using digital technology. The system and method uses icons to represent properties of interest to a user. The icons represent the location of properties available for sale, lease or rent as well as other attributes and their geographic location The size, shape and/or color of the icons represent specific indicia that provide specific information to the user regarding the associated property. In accordance with one embodiment of the invention, a method of properties in a real-estate market for a geographical area of interest on a is disclosed. The method first generates and displays a digital map of the rest. Property information for an item of property in the real-estate market of interest is obtained, wherein said property information includes at least a property type, a market price and a market status of the item of property. e property icon characteristic is determined from the property information. icon with the at least one property icon characteristic is displayed on the at the location of the item of property, wherein the property icon is with the item of property in the real-estate market.

### BRIEF DESCRIPTION OF THE DRAWINGS

FIGS. 1A-1D illustrate example icons used to identify properties by type and market status.

FIG. 2 is a computer screen illustrating use of the inventive icons in a computer system.

### DESCRIPTION OF THE PREFERRED EMBODIMENT(S)

Reference will now be made in detail to the preferred embodiment(s) sent invention, examples of which are illustrated in the accompanying It is to be understood that the figures and the description of the present included herein illustrate and describe elements that are of particular to the present invention, while eliminating, for purposes of clarity, other at may be found in typical auction systems and computer networks.

It is worthy to note that any reference in the specification to “one t” or “an embodiment” means that a particular feature, structure or ic described in connection with that embodiment is included in at least one t of the invention. The appearance of the phrase “in one embodiment” in aces in the specification are not necessarily all referring to the same .

The invention described in the co-pending application which is d herein by reference is a system and method which uses digital to acquire and then present in integrated form information-relating to one roperties in a real-estate market. The information may correspond to or residential property that is offered for sale, lease, or rent in a particular at has been recently deactivated from available properties as a result of of a contract on the property for sale, lease or rent thereof, or confirmation ract. When equipped with appropriate interface software, the information ed by agents and/or buyers alike in pinpointing property that most likely e prospective buyers needs, or provide the most useful market information.

As described in the above-referenced co-pending application, the system has a map generation unit for generating a digital map for n on the display of a terminal. The digital map covers areas in a real-estate t have been designated by a user using a keyboard or other input device. may cover one or more counties, cities, or towns in a state. If memory ts permit, a map of an entire state or multi-state region of the country (e.g., antic region) may be generated.

Preferably, the maps generated by map generation unit, as described in ing application, are detailed enough to show streets in at least a portion of d geographic area. Other features typically found on paper maps may also including but not limited to: topological features (e.g., bodies of water, etc.), parks, military installations, schools, churches, temples, amenities ping areas, food, lodging, etc.), recreational facilities (e.g, golf courses, pools, community centers, etc.), subway and/or train routes, airports, t buildings, and zoning information. For convenience purposes, the streets eatures on the map may be labeled by one or more symbols or icons.

The system disclosed in the co-pending application also uses a storage e information considered to be important by a real-estate agent and/or to a buyer when searching for property to buy, lease, or rent. The storage unit contains property information derived from the Multiple Listing Service is information includes specific data on the properties available for sale, nt in a given market, including location (e.g., address, apartment number, etc.) data, price, amenities (e.g., deck, finished basement, hot tub, etc.), nd types of bathrooms, bedrooms, lot size, model type, status data such as e property is available, been sold, or is under contract, and MLS listing hich may be used for future reference or tracking purposes. Information the real-estate broker and/or his or her contact information may also be the storage unit.

Other data not usually found in an MLS database may also be included age unit, such as digital images (e.g., JPEG files) or movie clips (e.g., s) of properties in the market.

The storage unit may be part of the mobile device, or alternatively may storage device. For example, the storage device could be a remote server to a network.

The disclosed system also includes an application program for various management functions. These management functions include information from the map generation and storage units based on various and commands, as well as integrating this information for presentation on of the terminal.

The method described in the co-pending application begins by having a agent or other user enter preferred property information into the terminal fies a geographical area having one or more properties available in a a second step, the preferred property information entered in the first step is asis for generating a digital map by the map generation unit. The digital cover all or part of the area specified according to one or more userettings or a default setting. In a third step, the processor searches the t based on the preferred property information entered by the user, and more y to generate a list of properties in the specified area and/or their ing attributes. These attributes may include information from the MLS, rmation, or other customized information considered important to a buyer g for a home, apartment, lot, etc.

In a fourth step, the processor associates the property attribute n obtained from the third step with the digital map generated in the second m an integrated output on the display of the user's terminal. The integrated dvantageously arranged in selected areas of a dedicated computer screen all or part of the graphical user interface.

In a preferred embodiment, the system disclosed in the aboveco-pending application operates on a stand-alone, mobile terminal, such as rsonal digital assistant, pocket-PC or other portable device.

In addition, the mobile terminal in the system disclosed in the aboveco-pending application is connected to a location positioning system via a communications link. The positioning system is preferably the Global Positioning System (GPS). The terminal includes a location data receiver, or GPS receiver, adapted to operate with a digital map. The GPS receiver receives location data from the GPS system. This location data specifies the current position of the mobile terminal, which is input into the processor and an icon representing the current position of the terminal is shown on the digital map. As the user moves with the terminal, the icon is continuously updated and moves in a corresponding manner on the digital map. As a result, the user can observe his location on the digital map relative to the locations to the properties identified by the property icons.

The present invention is directed to an improvement to the disclosed system wherein the icons used to represent properties in the market provide information about the property associated with the icon. As is known to those skilled in the art, an icon at a location on a map may be used to represent an object, such as a piece of real property, sited at that position. However, an icon according to the present invention provides more information than just location in that icon indicia such as relative size, color and shape, are correlated to market information for the item of property represented by the icon.

In a preferred embodiment, two or more property attributes are used to determine icon indicia. In the example given herein, at least one icon indicia is determined by type of property and market status information of the corresponding item of property. Specifically, icon shape and color are determined by the combination of property type and market status. As will be obvious to those skilled in the art, the icons could be constructed such that further property information, such as square-footage range or lot acreage, could be also, or alternatively, be used to determine icon indicia.

In the example given herein, the shape of the icon represents a property market status. In particular, the icon shape is determined by whether the a townhouse or a single-family detached home, and is also determined by status of the property, i.e. currently available for sale, lease or rent, under r a contract on the property has been consummated, i.e. whether a sale, tal of the property has been completed so as to take the property out of or ket. In the example given herein, these two attributes of the property termine the shape of the icon used to represent the property on a map. As ious to those skilled in the art, different attributes, or additional attributes, natively be used to determine property icon shape, or other indicia.

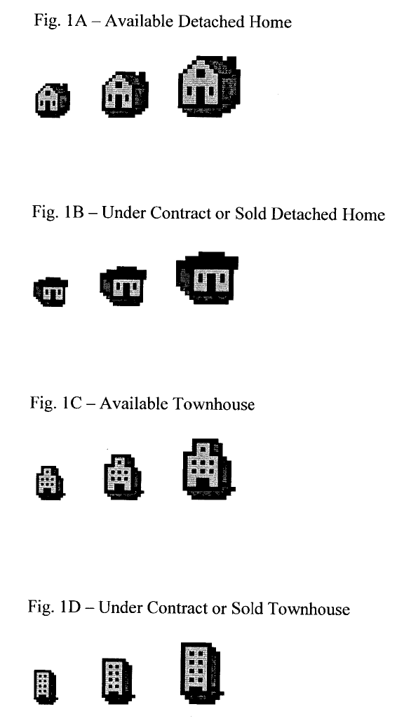

FIGS. 1A-1D illustrate the different types of icons used in the example . 1A illustrates the icon used to represent a detached single-family home ently available and several sizes of this icon to represent different attributes rty. FIG. 1B illustrates the icon used to represent a detached single-family is either under contract, or has been sold, and several sizes of the icon to ifferent attributes of the property. In a preferred embodiment, only at has recently been sold will be shown on the digital map generated by the is is for a number of reasons. First, typically, the price of recent sales is gnificant factor when determining fair market value of a property. Second, which is typically used when generating the digital map, has recent sales le, as well as sales contract information, but does not typically include ales data. As will be obvious to one skilled in the art, in an alternative , it may be possible to use the icons of the present invention with a also includes historical data.

FIG. 1C illustrates the icon used to designate a townhouse-style hat is currently available in the market and icons of different sizes to other attributes of the property. FIG. 1D illustrates the icon used to townhouse-style property that has been recently sold or is under contract f different sizes to represent other attributes of the property.

FIG. 1 illustrates icons having actual house shapes to indicate the type . That is, the icon used to identify a townhouse property has a townhouse. As will be obvious to one skilled in the art, any kind of shape could be example, a triangle could be used to indicate an available townhouse style square to indicate an available detached single-family home, a circle to wnhouse under contract and an oval to indicate a detached single-family r contract. It is not required that the shape of the icon directly represent the erty.

With respect to the use of icons of different sizes, the relative size may market price, lot size or acreage, for example. For example, the smallest present a smallest price range in a particular market, for example, between nd $150,000.

As will be obvious to those skilled in the art, the combination of tributes could be used to determine icon indicia other than shape. For our different icon colors could be used to indicate the four different ns of the property type and market status in the example given herein. As e obvious to those skilled in the art, a combination of more than two tributes could be used to determine icon indicia, and different indicia may ned from different property attributes, or combinations of property

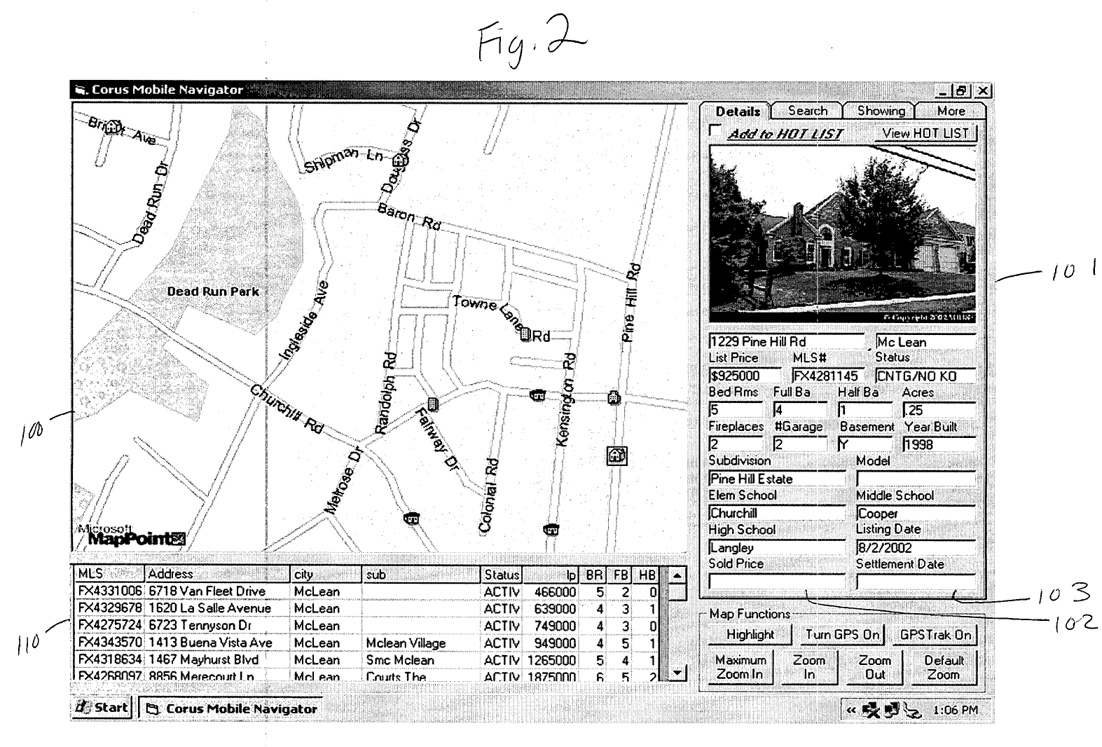

FIG. 2 illustrates a computer screen generated by the system disclosed in the co-pending application as a result of a user entering location data designating a geographical area within McLean, Va. As shown, the results of the search are integrated with the map. In the particular example shown, the integration includes the overlaying of property icons on the map, where each icon represents the location of a property in the region covered. In accordance with present invention, the icons are indicative of the type of property and its market status. The display of the inventive icons on the digital map advantageously gives a user a clear indication of the types and status of properties in the area, as well as their locations.

The location of each property icon on the map is derived, for example, from the MLS information produced from the storage unit as a result of the search. For example, in the area of McLean shown, the processor search produced nine properties in the area covered by the map. The MLS information corresponding to these properties include addresses that are used by the processor to generate and then overlay the nine property icons that appear on map 100. A textual listing of these properties with one or more attendant attributes were then displayed in a separate window 110 adjacent the map. This textual listing included information such as MLS number, street address, city, housing development name, market status (e.g., active, contract, sold, etc.), lot price and/or size, numbers of bedrooms, bathrooms, etc.

If the user selects one of the displayed icons using an input device such as a mouse, trackball, or touch pad, additional information specific to the selected property appears in window areas 101 of the display. This information may include media information, as shown by the digital picture in FIG. 2. Each selection of an icon by the user causes the processor to automatically output related media and/or textual information in windows 101. The textual information may include current owner information, property specification information, and price or sales information, for

As will be obvious to one skilled in the art, the inventive icons could many different types of real-estate systems, and should not be limited to the system disclosed in the above-referenced co-pending application.

The use of the inventive icons provides a great deal of additional value f real-estate information system in a number of ways. For example, if the is primarily interested in single-family detached homes that are currently he may quickly identify these by the icon used. Recently sold detached the area of interest are also represented on the digital map, so the home be able to quickly ascertain market trends by looking at the property n available for the properties represented by these icons. This information hown, for example, in the “Sold Price” 102 and “Settlement Date” 103 e detailed property information window 101.

One variation to the method of the present invention contemplates the color indicia to provide additional information. Color of the icon could be resent property type, the combination of color and shape may also be used on the property attributes that can be displayed. That is, a property whose ype is “townhouse style” may be identified by both the icon shape and rnatively, the color of an icon could be used to provide addition property formation, such as length of time that the property has been on the market. mple, users would be able to quickly spot or identify properties that have d the market, for instance. It is intended by the present invention that the ics of the icon, such as its shape, color or size, could be used to indicate a attributes of the underlying property of interest to a prospective buyer. ive attributes include; cost: high, medium and low, that could be by icon size; property type: detached single family home, townhouse, um, that could be represented by icon shape; and market status, represented lor, e.g. sold, under contract and available. Thus, a medium-sized icon, e a house and colored red, for example, might identify detached singlee, in the price range of $150,000-$200,000 that is currently under contract.

While the inventive icons have been described in connection with the system of the above-referenced co-pending application, it is intended that can be used in any type of real-estate information system to identify having certain combination of attributes.

Other modifications and variations to the invention will be apparent to ed in the art from the foregoing disclosure. Thus, while only certain ts of the invention have been specifically described herein, it will be hat numerous modifications may be made thereto without departing from nd scope of the invention.

We claim:

1. A method of identifying properties in a real-estate market for a geographical area of interest on a digital map, comprising:
generating and displaying a digital map for said area of interest;
defining a plurality of property attributes for items of property in the real-estate market or the area of interest;
determining at least one property icon indicia corresponding to said property attributes; and
displaying one or more property icons with the at least one property icon indicia at locations of the items of property on the digital map, wherein an item of property associated with a property icon has the attributes corresponding to the icon's indicia.

2. The method of claim 1, wherein said property attributes include at least a property type and a market status

3. The method of claim 1, wherein said at least one property icon indicia is selected from the group consisting of icon shape, color and size.

4. The method of claim 1, wherein at least two property icon indicia are determined from said property attributes.

5. The method of claim 4, wherein said at least two property icon indicia are icon shape and color.

6. The method of claim 5, wherein at least one property icon indicia is icon shape, and a first icon shape is determined for a property type of detached house and market status of available, a second icon shape is determined for a property type of detached house and market status of sold, a third icon shape is determined for a property type of townhouse and market status of available, and a fourth icon shape is determined for a property type of townhouse and market status of sold.

7. The method of claim 5, wherein at least one property icon indicia is color, and a first color is determined for a market status of available, and a second color is determined for a market status of sold.

8. The method of claim 1, wherein said at least one property icon indicia is icon relative size.

9. The method of claim 8, wherein a first icon relative size is determined for a first property price range, and a second icon relative size is determined for a second relative price range.

10. The method of claim 8, wherein a first icon relative size is determined for a first property acreage size range, and a second icon relative size is determined for a second acreage size range.

11. The method of claim 1, wherein said property icon is a selectable icon, said method further comprising:
selecting said icon with an input device; and
displaying, in response to said selecting step, at least one of a digital image of said item of property, demographics information related to said item of property, current owner information, property specification information, price information, and market status information.

12. The method of claim 1, further comprising:
receiving location data indicative of a current location of a user in said area of interest; and
automatically generating said digital map including said area of interest based on the location data received in said receiving step.

13. The method of claim 1, further comprising:
receiving location data indicative of a current location of a user in said area of interest; and
displaying, on said digital map, information indicative of the current location of said user in said area of interest.

14. The method of claim 1, wherein said property attributes are obtained from a database of MLS listings.

15. The method of claim 1, wherein said generating, defining, and displaying steps are performed in a user terminal, and wherein said property attributes are obtained from a database stored in the user terminal.

16. The method of claim 1, wherein said generating, defining, and displaying steps are performed in a user terminal, said method further comprising obtaining said property attributes from a remote database.

17. The method of claim 1, wherein said defining step includes obtaining property attributes for a plurality of items of property in said area of interest, said determining step includes determining said at least one property icon indicia for each item of property based on its property attributes, and said displaying step includes displaying a property icon with the determined property icon indicia for each of said plurality of items of property in association with said digital map.

18. A real-estate market property icon for use in a real estate information system, wherein the property icon is associated with an item of property,
wherein said item of property has at least two property attributes, including at least a property type and a market status;
wherein said property icon is displayed at said item of property's location on a digital map in the real estate information system; and
wherein said property icon has a shape, size or color that is indicative of said at least two property attributes of the item of property.

19. The property icon of claim 18, wherein at least two property attributes are property type and market status.

20. The property icon of claim 19, wherein the shape of the property icon is indicative of property type and market status, and a first shape indicates a first property type and a first market status, a second shape indicates the first property type and a second market status, a third shape indicates the second property type and the first market status, and a fourth shape indicates the second property type and the second market status.

21. The property icon of claim 20, wherein the shape of the first shape indicates a first property type of detached house and a first market status of available, a second shape indicates the first property type of detached house and a second market status of sold, a third shape indicates a second property type of townhouse and the first market status of available, and a fourth shape indicates the second property type of townhouse and the second market status of sold.

22. The property icon of claim 19, wherein the property icon has a color that is indicative of a property attribute of the item of property.

23. The property icon of claim 22, wherein the color of the property icon is a first color to indicate a first market status, and a second color to indicate a second market status.

24. The real estate market property icon of claim 18, wherein said real estate information system is resident on a mobile terminal.

25. The real estate market property icon of claim 18, wherein said property attributes are obtained from a database containing MLS listings.

26. A computer-readable medium containing instructions that cause a computer to display a property icon in a real estate information system, said medium comprising:
a storage section for storing a plurality of property icons;
a first code section for defining a plurality of property attributes for an item of property in an area of interest;
a second code section for determining which stored property icon to display in the real estate information system, wherein at least two property attributes defined for the item of property are used to determine a property icon; and
a third code section for displaying the determined property icon in the real estate information system at the item of property's location, wherein the item of property associated with determined property icon has the at least two attributes used to determine the property icon.

27. The computer-readable medium of claim 25, wherein the property icon is a selectable icon, said computer-readable medium further comprising:
a fourth code section for receiving information indicative of a selection of said icon by a user; and
a fifth code section for displaying, in response to said selection, at least one of a digital image of said item of property, demographics information related to said item of property, current owner information, property specification information, price information, and market status information.

28. The computer readable medium of claim 26, wherein said code sections and storage section are located on a portable computing device.

29. The computer readable medium of claim 26, wherein said plurality of property icons comprise an available detached house icon, an available townhouse icon, a sold detached house icon and a sold townhouse icon.

30. The computer readable medium of claim 29, wherein said available detached house icon and available townhouse icon are a first color, and said sold detached house icon and sold townhouse icon are a second color.
